(19) United States
(12) Patent Application Publication
(10) Pub. No.: US 2005/0228682 A1
(43) Pub. Date: Oct. 13, 2005

(54) Method and system for tracking medical and other waste

(75) Inventor: Russell A. Firestone III, Washington, DC (US)

Correspondence Address: PATTON BOGGS LLP, 8484 WESTPARK DRIVE, SUITE 900, MCLEAN, VA, 22102, US

(73) Assignee: Sanitec Industries, Inc., a California Corporation, Studio City, CA (US)

(21) Appl. No.: 10/821,849

(22) Filed: Apr. 12, 2004

(51) Int. Cl. G06F 17/60

(52) U.S. Cl. 705/1

(57) ABSTRACT

A system and method for tracking medical or toxic waste including a first container adapted to hold untreated medical waste, the container having a wireless tracking device attached thereto. The system also includes a tracking station capable of monitoring the movement of the medical waste by tracking the wireless tracking device.

### FIELD OF THE INVENTION

The present invention is directed generally to the tracking of waste and specifically to the tracking of medical and other toxic or hazardous waste.

### BACKGROUND OF THE INVENTION

The generation and destruction of industrial and medical waste is a serious problem that has become increasingly more important each year as the volume of waste generated continues to increase. This is especially true for medical waste as it typically includes toxic and/or infectious matter.

Although there are many regulations that govern the actual destruction of industrial and medical waste, historically there was very little regulation governing the tracking of this waste. This lack of regulation has occasionally resulted in abuse as the waste was improperly and/or illegally dumped rather than destroyed. In fact, because of widespread mismanagement, medical wastes began washing ashore along the Atlantic Coast during the summer of 1988.

In response to the medical waste disaster of 1988, the United States Congress passed the Medical Waste Tracking Act. The Act requires the use of a tracking form for all facilities that generate over 50 pounds a month of medical waste and for all shipments over 50 pounds. On the form, the generator must put the facility name and address, the identity of the transporter, the intended destination facility and the waste category. Additionally, the Act requires that medical waste producers segregate waste at the point of generation, place waste in containers that protect waste handlers and the public from exposure, and label the waste containers appropriately.

The cost of compliance with this method of tracking is relatively high and has resulted in widespread noncompliance. Because of the extent of noncompliance and the paucity of funds for enforcement, the EPA has typically ignored the problem. This has only encouraged others to ignore the statute, further increasing the problem. Thus, it would be advantageous to have a cheaper method of tracking medical and industrial waste that is easier to monitor and enforce.

### SUMMARY OF THE INVENTION

The present invention provides a method of tracking medical waste comprising monitoring the movement of a first container having a wireless tracking device attached thereto from a waste generating facility to a waste treatment facility using the wireless tracking device.

The present invention also includes a system for tracking medical waste comprising a first container adapted to hold untreated medical waste, the container having a wireless tracking device attached thereto, and a tracking station capable of monitoring the movement of the medical waste by tracking the wireless tracking device.

### BRIEF DESCRIPTION OF THE DRAWINGS

The foregoing and other features, aspects and advantages of the present invention will become apparent from the following description, appended claims and the exemplary embodiments shown in the drawings, which are briefly described below. It should be noted that, unless otherwise specified, like elements have the same reference numbers.

FIG. 1 is a schematic illustration of a wireless tracking system according to one embodiment of the invention.

FIG. 2 is a schematic illustration of a container having a wireless tracking device used in a method according to an embodiment of the invention.

FIG. 3 is a schematic illustration of another embodiment of the invention.

### DETAILED DESCRIPTION OF THE PREFERRED EMBODIMENTS

The present inventors have determined that by using a wireless tracking system, a method of tracking medical and industrial waste can be implemented that is both cost effective and easy to enforce. In short, by supplying waste generators with containers having a wireless tracking device attached, it is possible to dynamically track the movement of untreated waste to a treatment facility. In one preferred embodiment of the invention, individuals with handheld readers scan the tracking device at various points along the disposal route. The information can then be upload from the handheld reader to a central monitoring station. In another preferred embodiment, the tracking is accomplished by use of GPS technology. When the waste is destroyed, the operator of the waste treatment facility can send a signal to the monitor to indicate the destruction. Optionally, an invoice may be generated and the customer billed. Additionally, the treated waste may be placed in a second container having a wireless tracking device attached and the movement of the treated waste tracked until its final disposition.

For the purposes of this disclosure, medical waste may include, but is not limited to:
(1) cultures and stocks of infectious agents and associated Biologicals, including cultures from medical and pathological laboratories, cultures and stocks of infectious agents from research and industrial laboratories, wastes from the production of biologicals, discarded live and attenuated vaccines, and culture dishes and devices used to transfer, inoculate, and mix cultures;
(2) pathological wastes, including tissues, organs, and body parts that are removed during surgery or autopsy;
(3) waste human blood and products of blood, including serum, plasma, and other blood components;
(4) sharps that have been used in patient care or in medical, research, or industrial laboratories, including hypodermic needles, syringes, pasteur pipettes, broken glass, and scalpel blades;
(5) contaminated animal carcasses, body parts, and bedding of animals that were exposed to infectious agents during research, production of biologicals, or testing of pharmaceuticals;
(6) wastes from surgery or autopsy that were in contact with infectious agents, including soiled dressings, sponges, drapes, lavage tubes, drainage sets, underpads, and surgical gloves;
(7) laboratory wastes from medical, pathological, pharmaceutical, or other research, commercial, or industrial laboratories that were in contact with infectious agents, including slides and cover slips, disposable gloves, laboratory coats, and aprons;
(8) dialysis wastes that were in contact with the blood of patients undergoing hemodialysis, including contaminated disposable equipment and supplies such as tubing, fitters, disposable sheets, towels, gloves, aprons, and laboratory coats;
(9) discarded medical equipment and parts that were in contact with infectious agents;
(10) biological waste and discarded materials contaminated with blood, excretion, excudates or secretion from human beings or animals who are isolated to protect others from communicable diseases;
(11) radioactive waste used industrially and in medical procedures as well as chemical waste used in the production of reagents used in laboratories and medical facilities; and
(12) such other waste material that results from the administration of medical care to a patient by a health care provider and is found by the administrator to pose a threat to human health or the environment.

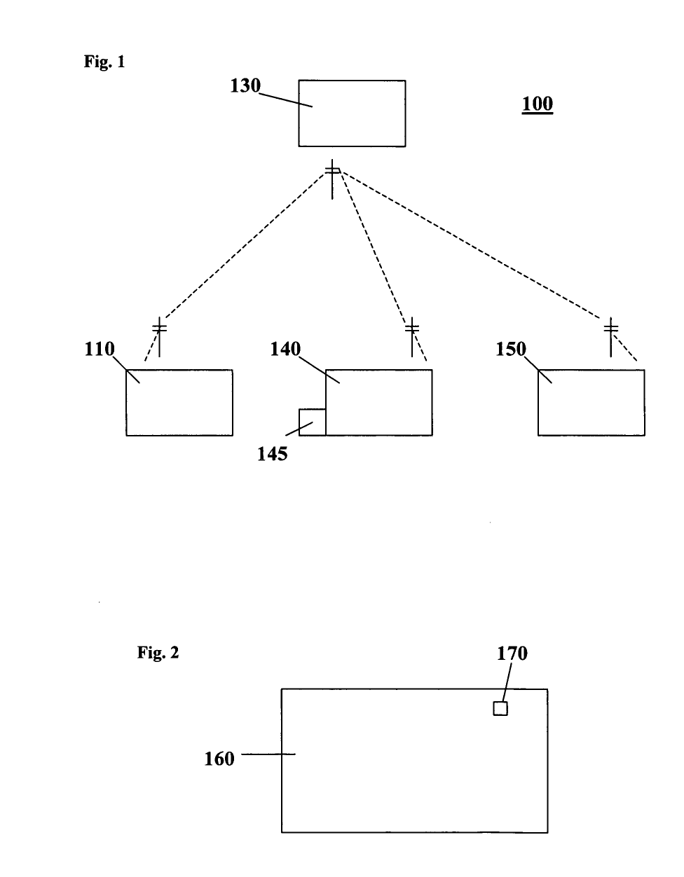

One embodiment of a wireless waste tracking system 100 according to the present invention is illustrated in FIGS. 1 and 2. This embodiment of the invention includes a waste disposal container 160 (FIG. 2) having a wireless tracking device 170. The tracking device 170 may be affixed to the container 160 by relatively permanent method such as welding or gluing. However, the tracking device 170 may be replaceably affixed to the container 160, for example by a snap fit. Indeed, the tracking device can also be simply added to the waste as a component the will end up deposited with the waste at its final destination, for example at a landfill.

The wireless tracking system 100 also includes a tracking station 130. The tracking station 130 is equipped with a computer system (not shown) that stores tracking information as the waste disposal containers 160 are shipped from a waste generator 110 to a waste treatment facility 140. In this embodiment, an operator reads tracking information from the tracking device using a handheld reader (not shown) and downloads the information to the computer at the monitoring station 130. The downloading may be done over the phone lines or through a wireless communications network. Additionally, the movement of the waste disposal containers 160 may also be monitored as they are shipped from the waste treatment facility 140 to a final destination 150 for the waste. Readings with a handheld reader may be taken at each step in this process and the computer log updated throughout the delivery from the initial pickup at the waste generator 110 to the final destination 150.

Typically, the waste generator 110 is a hospital, urgent care center, or medical practice. However, the waste generator 110 may also include a ranch with diseased animals, a farm or orchard with diseased fruit, a customs inspection center with banned products, a factory with toxic waste or any other producer of waste that should be tracked to ensure proper disposal. The waste treatment facility 140 may be a chemical treatment plant, an industrial incinerator or any other facility suitable for destroying or denaturing medical or toxic waste. Typically, the final destination 150 is a municipal dump, landfill or a recycling plant. However, the final destination 150 may be any facility or ground suitable for processing or holding treated waste.

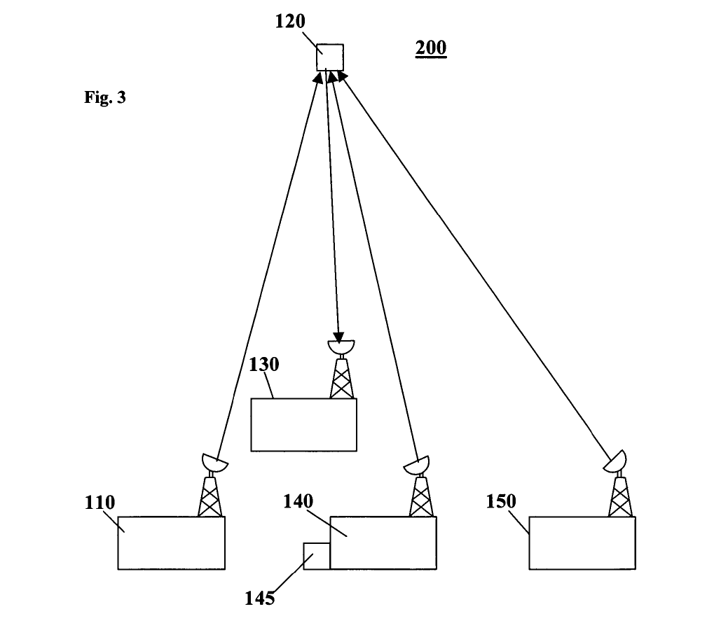

FIG. 3 illustrates another embodiment of the invention. The wireless tracking system 200 also includes a tracking station 130. The tracking station 130 is equipped to continuously monitor the movement of waste disposal containers 160 as they are shipped from a waste generator 110 to a waste treatment facility 140. Further, the tracking station 130 is equipped to continuously monitor the movement of waste disposal containers 160 as they are shipped from the waste treatment facility 140 to a final destination 150 for the waste.

In this embodiment, the wireless waste tracking system 200 typically includes a communications forwarding device 120. The communications forwarding device 120 may be any type of device that can monitor and forward signals from a wireless tracking device 170. The communications forwarding device 120 may be, for example, a satellite or cellular receiving station. In a preferred embodiment of the invention, the tracking device 170 and the communications forwarding device 120 operate in radio frequency and may be integrated into the GPS system. However, the tracking device 170 and the communications forwarding device 120 may operate at any portion of the electromagnetic spectrum, for example microwave frequencies.

Methods according to the present invention will now be discussed. In a first embodiment of the method, the waste generator 110 puts untreated waste (not shown) in a waste disposal container 160 (FIG. 2) having a tracking device 170. When the waste disposal container 160 is full, or the decision is made to dispose of the waste, the waste generator 110 arranges to ship the waste to a waste treatment facility 140. If the first system 100 is used, either an operator at the waste generator 110 or an operator associated with a waste transporter can take an initial reading with a handheld reader and send the data to the tracking station 130.

In a preferred embodiment of the invention, the waste treatment facility 140 includes a weighing apparatus 145 which can determine the weight of the waste without removing it from the waste disposal container 160. In another preferred embodiment, the waste treatment facility 140 also includes a computer (not shown) with billing software. When the waste is destroyed, the computer calculates how much the customer owes based on the weight and type of waste destroyed. The type of waste destroyed may either be read from the tracking device or inputted by an operator at the waste treatment facility 140. Preferably, the computer also generates an electronic invoice/bill confirming the destruction of the waste, the amount of the waste destroyed and the amount owed by the customer.

In still another embodiment of the invention, the treated waste is placed in a second waste disposal container 160 having a tracking device 170 and shipped to a final destination 150. Typically, the final destination is a municipal dump. However, depending on the type of waste, the final destination 150 may be a recycling center. Preferably, the final destination 150 includes a device (not shown) for generating an invoice that confirms receipt of the treated waste. The invoice may also include information indicating if further payment is required or a credit is due the customer.

The foregoing description of the invention has been presented for purposes of illustration and description. It is not intended to be exhaustive or to limit the invention to the precise form disclosed, and modifications and variations are possible in light of the above teachings or may be acquired from practice of the invention. The drawings and description were chosen in order to explain the principles of the invention and its practical application. It is intended that the scope of the invention be defined by the claims appended hereto, and their equivalents.

1. A method of tracking medical or toxic waste comprising:
monitoring the movement of a first container having a wireless tracking device attached thereto from a waste generating facility to a waste treatment facility using the wireless tracking device.

2. The method of claim 1, further comprising:
monitoring the return of the first container from the waste treatment facility to the waste generating facility with the wireless tracking device.

3. The method of claim 2, wherein monitoring comprises scanning the wireless tracking device with a handheld reader.

4. The method of claim 3, further comprising uploading tracking data to a monitoring station.

5. The method of claim 1, wherein the medical waste is segregated according to type prior to putting it in the medical waste container.

6. The method of claim 5, further comprising weighing the first container with waste prior to treating the waste.

7. The method of claim 6, further comprising determining the amount of waste in the container.

8. The method of claim 7, further comprising calculating how much to charge a customer based on the type of waste and the weight of the waste.

9. The method of claim 8, further comprising electronically billing the customer.

10. The method of claim 9, further comprising supplying the customer with an invoice, the invoice including confirmation of the destruction of the waste and the amount of waste destroyed.

11. The method of claim 10, further comprising supplying a second container having an wireless tracking device, the second container adapted to hold treated medical waste.

12. The method of claim 11, further comprising tracking the second container to a landfill or recycling center.

13. The method of claim 12, further comprising supplying the customer with an invoice, the invoice including confirmation of the delivery of the waste to the landfill or recycling center.

14. The method of claim 13, wherein the wireless tracking device operates at radio frequencies.

15. A system for tracking medical or toxic waste comprising:
a first container adapted to hold untreated medical waste, the container having a wireless tracking device attached thereto; and
a tracking station capable of monitoring the movement of the medical waste by tracking the wireless tracking device.

16. The system of claim 15, further comprising at least one handheld reader.

17. The system of claim 15, further comprising a satellite or cellular station.

18. The system of claim 17, further comprising a computer to track said container.

19. The system of claim 18, further comprising an apparatus for weighing the first container and untreated medical waste.

20. The system of claim 19, further comprising an apparatus for calculating how much to charge a customer based on the type of waste and the weight of the waste and for supplying the customer with an invoice, the invoice including confirmation of the destruction of the waste and the amount of waste destroyed.

21. The system of claim 20, further comprising a second container having an wireless tracking device, the second container adapted to hold treated medical waste.

22. The system of claim 21, wherein the wireless tracking operates at radio frequencies.

23. The method of claim 5, wherein the segregated waste comprises sharps containers.

24. The method of claim 23, further comprising processing the sharps containers and sending the processed sharps containers to a recycling facility.

25. The method of claim 24, further comprising fabricating new sharps containers from the recycled sharps containers.
